(19) United States
(12) Patent Application Publication
(10) Pub. No.: US 2023/0015069 A1
(43) Pub. Date: Jan. 19, 2023

(54) FOLDING PLATFORM TYPE BICYCLE CARRIER

(71) Applicant: ShenZhen Suncent Auto Parts Technology Company Lim, Shenzhen (CN)

(72) Inventors: Chenghao Li, Shenzhen (CN); Li Yu, Shenzhen (CN); Zongyi Li, Shenzhen (CN); Xiangpei Wu, Shenzhen (CN); Wei Xiang, Shenzhen (CN)

(73) Assignee: ShenZhen Suncent Auto Parts Technology Company Limited, Shenzhen (CN)

(21) Appl. No.: 17/951,121

(22) Filed: Sep. 23, 2022

(30) Foreign Application Priority Data
Aug. 26, 2022 (CN) 202222294853.3

(51) Int. Cl. B60R 9/10

(52) U.S. Cl. CPC B60R 9/10

(57) ABSTRACT

The present disclosure discloses a folding platform type bicycle carrier, including a fixed connection mechanism, which is detachably connected to a rectangular pipe at the rear part of a vehicle; a rotating mechanism, which is movably connected to the fixed connection mechanism and can rotate relative to the fixed connection mechanism, wherein the rotating mechanism includes a rotating cavity, a connection rod, a pull handle, a connection block, an elastic piece and a rotating head; a longitudinal adjustment rod, which is movably arranged above the rotating mechanism and can be folded relative to the rotating mechanism; at least one longitudinal adjustment fixing mechanism, which is movably arranged on the longitudinal adjustment rod and is movable on the longitudinal adjustment rod; two transverse adjustment rods, and at least two transverse adjustment fixing mechanisms.

### TECHNICAL FIELD

The present disclosure relates to the technical field of platform type bicycle carriers, in particular, to a folding platform type bicycle carrier.

### BACKGROUND

A platform type bicycle carrier is mounted at a rear part of a vehicle and is a device for transporting bicycles, so as to solve the problem that it is convenient to carry a bicycle in a vehicle because the bicycle has a large volume. The platform type bicycle carrier is favored by the majority of cycling fans.

The patent No. CN208036136U provides a platform type bicycle carrier, including an underframe, a bracket and a body fixing part; the underframe includes a rear connection rod, a connection piece and a bracket fixing rod; the rear connection rod is fixed at a rear part of a vehicle; an upper part of the connection piece is of an inverted T-shaped rodlike structure, and a lower part is of a groove structure with a groove bottom connected to a lower part of the inverted T-shaped rodlike structure; the groove structure is connected to the rear connection rod through a pin close to a tail end of the rear connection rod, and a gap is formed in the tail end of the rear connection rod; the bracket fixing rod is fixedly connected to the connection piece in a horizontal direction, and brackets are mounted on two sides of the bracket fixing rod; the body fixing part includes a body fixing rod and a body fixing hook mounted on the body fixing rod; the body fixing rod is provided with a plurality of through holes at different heights; and the body fixing hook is mainly composed of a fixing hook clamping part, a fixing hook body connected to the fixing hook clamping part, and an adjustment device for adjusting the height of the fixing hook body. In this solution, the overall platform type bicycle carrier occupies a large volume, which is inconvenient for storage and transportation of the platform type bicycle carrier. Therefore, a folding platform bicycle carrier is provided to solve the above problems.

### SUMMARY

One of the purposes of the present disclosure is to provide a folding platform type bicycle carrier, so as to solve the above-mentioned problems.

A folding platform type bicycle carrier of the present disclosure can be achieved by the following technical solutions:

The folding platform type bicycle carrier of the present disclosure includes a fixed connection mechanism, which is detachably connected to a rectangular pipe at the rear part of a vehicle; a rotating mechanism, which is movably connected to the fixed connection mechanism and can rotate relative to the fixed connection mechanism, wherein the rotating mechanism includes a rotating cavity, a connection rod, a pull handle, a connection block, an elastic piece and a rotating head; the rotating cavity is a hollow cavity, which can rotate relative to the fixed connection mechanism through a rotating shaft; the rotating rod is movably arranged in the rotating cavity, and two ends of the rotating rod are respectively fixedly connected to the pull handle and the connection block; the pull handle is movably arranged on an outer side of the rotating cavity, and drives the connection rod and the connection block to move to the outside in sequence; the connection block is arranged in the rotating cavity and can run through the rotating head; the elastic piece is arranged on the connection rod in a penetrating manner, and two ends of the elastic piece are respectively connected to the connection block and an inner wall of the rotating cavity; the elastic piece provides a restoring force for the connection rod; the rotating head is fixedly arranged at one end of the rotating cavity and can rotate relative to the fixed connection mechanism; a longitudinal adjustment rod, which is movably arranged above the rotating mechanism and can be folded relative to the rotating mechanism; at least one longitudinal adjustment fixing mechanism, which is movably arranged on the longitudinal adjustment rod and can move on the longitudinal adjustment rod; two transverse adjustment rods, which are respectively arranged on two sides of the rotating mechanism; and at least two transverse adjustment fixing mechanisms, which are respectively movably arranged on the corresponding transverse adjustment rods, wherein each transverse adjustment fixing mechanism can move on the corresponding transverse adjustment rod.

Preferably, the fixed connection mechanism includes a connection pipe, a fixed connection structure and a connection head; the connection pipe is a hollow pipe, which is detachably connected to the rectangular pipe at the rear part of the vehicle through the fixed connection structure; the fixed connection structure is arranged in one end of the connection pipe and runs through the connection pipe to be in contact connection with the rectangular pipe; and two ends of the connection head are respectively connected to the connection pipe and the rotating mechanism.

Preferably, a via hole is formed in the connection pipe; the via hole is arranged above the connection pipe; and the fixed connection structure runs through the via hole and is connected to the rectangular pipe.

Preferably, the fixed connection structure includes a guide block, a fastening block, at least one guide rod and a screw rod; the guide block is movably arranged in the connection pipe, and an internal thread is formed in the guide block; the fastening block is movably arranged on the guide block, runs through the connection pipe, and can be in contact connection with an inner wall of the rectangular pipe; two ends of the at least one guide rod are respectively fixedly arranged on opposite inner walls of the connection pipe; the screw rod is detachably connected to the guide block, and an external thread is arranged on the screw rod; and the external thread is matched with the internal thread.

Preferably, a plurality of first through holes are formed in a side edge of the connection pipe in a penetrating manner; and the at least one guide rod and the screw rod respectively run through the connection pipe through the corresponding first through holes.

Preferably, the two guide rods are disposed in parallel; and the guide block is movably arranged on the two guide rods respectively.

Preferably, the rotating cavity is T-shaped; the longitudinal adjustment rod is movably arranged in a longitudinal direction of the rotating cavity; and the two transverse adjustment rods are fixedly arranged on two sides of the rotating cavity.

Preferably, a side edge of the rotating cavity is movably provided with a limiting pin; and the limiting pin can be in contact connection with the longitudinal adjustment rod.

Preferably, the elastic piece adopts a spring.

Preferably, a plurality of adjustment toothed racks are uniformly arranged on the longitudinal adjustment rod at equal distances, and each longitudinal adjustment fixing mechanism is matched with the corresponding adjustment toothed rack.

Preferably, the longitudinal adjustment fixing mechanism includes a sliding cavity, a fastening block and a pressing block; the sliding cavity is a hollow cavity, which is movably arranged on the longitudinal adjustment rod; the fastening block is movably arranged between the sliding cavity and the pressing block and is in contact connection with the longitudinal adjustment rod; the pressing block is movably arranged on the sliding cavity and is in contact connection with the fastening block; and the pressing block presses the fastening block, so that the fastening block is fastened with the corresponding adjustment toothed rack.

Preferably, the longitudinal adjustment fixing mechanism further includes a longitudinal fixing rod; and the longitudinal fixing rod is fixedly arranged on a side edge of the sliding cavity.

Preferably, a lock body is arranged on the pressing block; and the pressing block is fixed on the sliding cavity through the lock body.

Preferably, two transverse adjustment fixing mechanisms are movably arranged on each transverse adjustment rod; and the two transverse adjustment fixing mechanisms are respectively arranged on two sides of the corresponding transverse adjustment rod.

Preferably, each transverse adjustment fixing mechanism includes an adjustment fixing structure and a transverse fixing rod; the adjustment fixing structure is movably arranged on the corresponding transverse adjustment rod; and the transverse fixing rod is fixedly arranged on a side edge of the adjustment fixing structure.

Compared with the prior art, the folding platform type bicycle carrier of the present disclosure has the beneficial effects:

According to the folding platform type bicycle carrier of the present disclosure, the connection rod and the connection block are driven in sequence by the pull handle to move to the outside, so that the connection block is separated from the connection head, and the rotating mechanism can rotate relative to the fixed connection mechanism to realize the function of folding the transverse adjustment rods and the transverse adjustment fixing mechanisms respectively relative to the fixed connection mechanism.

According to the folding platform type bicycle carrier of the present disclosure, the limiting pin is pulled to be separated from the longitudinal adjustment rod, and the longitudinal adjustment rod can rotate relative to the rotating mechanism, thereby realizing the function of folding the longitudinal adjustment rod and the longitudinal adjustment fixing mechanisms respectively relative to the rotating mechanism.

According to the folding platform type bicycle carrier of the present disclosure, the screw rod runs through the rectangular pipe, the connection pipe and the guide block respectively, and the screw rod is screwed manually or with a tool, so that the external thread on the screw rod and the internal thread on the guide block are matched; the guide block moves on the guide rods to drive the fastening block running through the connection pipe to be fastened to the inner wall of the rectangular pipe, thus achieving fixed connection between a fixed connection mechanism and the rectangular pipe.

According to the folding platform type bicycle carrier of the present disclosure, the pressing block presses the fastening block, so that the fastening block is fastened with the corresponding adjustment toothed rack, thus fixing a bicycle in a longitudinal direction and a transverse direction; meanwhile, the pressing block is provided with the lock body, so that the pressing block is fixed on the sliding cavity through the lock body to prevent the pressing block from being loosened; and an anti-theft function is achieved.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a schematic structural diagram of a folding platform type bicycle carrier of the present disclosure;

FIG. 2 is a schematic structural diagram of the other side of the folding platform type bicycle carrier of the present disclosure shown in FIG. 1;

FIG. 3 is a schematic structural diagram of the folding platform type bicycle carrier of the present disclosure shown in FIG. 1 in a folded state;

FIG. 4 is a schematic structural exploded diagram of the folding platform type bicycle carrier of the present disclosure shown in FIG. 1, including a fixed connection mechanism, a rotating mechanism, a longitudinal adjustment rod, a longitudinal adjustment fixing mechanism, a transverse adjustment rod and a transverse adjustment fixing mechanism;

FIG. 5 is a partially schematic structural exploded diagram of the fixed connection mechanism in the folding platform type bicycle carrier of the present disclosure shown in FIG. 4;

FIG. 6 is a schematic structural sectional diagram of the fixed connection mechanism in the folding platform type bicycle carrier of the present disclosure shown in FIG. 4;

FIG. 7 is a schematic structural exploded diagram of the rotating mechanism in the folding platform type bicycle carrier of the present disclosure shown in FIG. 4;

FIG. 8 is a schematic structural sectional diagram of the rotating mechanism in the folding platform type bicycle carrier of the present disclosure shown in FIG. 4;

FIG. 9 is a schematic structural diagram of the longitudinal adjustment rod and the longitudinal adjustment fixing mechanism in the folding platform type bicycle carrier of the present disclosure shown in FIG. 4;

FIG. 10 is a schematic structural sectional diagram of the longitudinal adjustment rod and the longitudinal adjustment fixing mechanism shown in FIG. 9; and

FIG. 11 is a schematic structural diagram of the transverse adjustment rod and the transverse adjustment fixing mechanism in the folding platform type bicycle carrier of the present disclosure shown in FIG. 4.

Numerals in the drawings: 11: fixed connection mechanism; 111: connection pipe; 1111: via hole; 1112: first through hole; 112: fixed connection structure; 1121: guide block; 1122: fastening block; 1123: guide rod; 1124: screw rod; 113: connection head; 12: rotating mechanism; 121: rotating cavity; 122: connection rod; 123: pull handle; 124: connection block; 125: elastic piece; 126: rotating head; 1261: second through hole; 127: limiting pin; 13: longitudinal adjustment rod; 131: adjustment toothed rack; 14: longitudinal adjustment fixing mechanism; 141: sliding cavity; 142: fastening block; 143: pressing block; 1431: pressing block main body; 1432: pressing block head; 144: lock body; 145: longitudinal fixing rod; 15: transverse adjustment rod; 16: transverse adjustment fixing mechanism; 161: adjustment fixing structure; and 162: transverse fixing rod.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. The components of the embodiments of the present disclosure generally described and shown in the drawings here can be arranged and designed in a variety of different configurations.

Therefore, the following detailed description for the embodiments of the present disclosure provided in the accompanying drawings is not intended to limit the scope of the claimed present disclosure, but merely represents selected embodiments of the present disclosure. All other embodiments obtained by those of ordinary skill in the art based on the embodiments in the present disclosure without creative work shall fall within the protection scope of the present disclosure.

It should be noted that similar reference signs and letters indicate similar items in the following drawings. Therefore, once a certain item is defined in one drawing, it is unnecessary to be further defined and explained in the subsequent drawings.

In the description of the present disclosure, it should be noted that orientations or positional relationships indicated by the terms “upper”, “lower”, and the like are orientations or positional relationships as shown based on the drawings, or orientations or positional relationships where this invention product are usually placed, and are only for the purpose of facilitating and simplifying the description of the present disclosure instead of indicating or implying that devices or elements indicated must have particular orientations, and be constructed and operated in the particular orientations, so that these terms cannot be construed as limiting the present disclosure.

In addition, in the present disclosure, unless otherwise clearly defined and defined, the first feature being above or under the second feature may include that the first and second features are in direct contact, or may include that the first and second features are not in direct contact but in contact through other features between them. Moreover, the first feature being “on”, “at the upper side of”, and “on the upper surface of” the second feature includes that the first feature is right above and at the oblique upper side of the second feature, or only indicates that the horizontal height of the first feature is greater than that of the second feature. The first feature being “below”, “at the lower side of”, and “on the lower surface of” the second feature includes that the first feature is right below and at the oblique lower side of the second feature, or only indicates that the horizontal height of the first feature is less than that of the second feature.

In addition, the terms “horizontal”, “vertical”, and the like do not mean that the component is required to be absolutely horizontal or overhanging, but may be slightly inclined. For example, “horizontal” only means that its direction is more horizontal than “vertical”, and it does not mean that the structure must be completely horizontal, but can be slightly inclined.

In the description of the present disclosure, it should be also noted that unless otherwise explicitly defined and defined, the terms “arranged”, “coupled” and “connected” shall be understood broadly, and may be, for example, fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

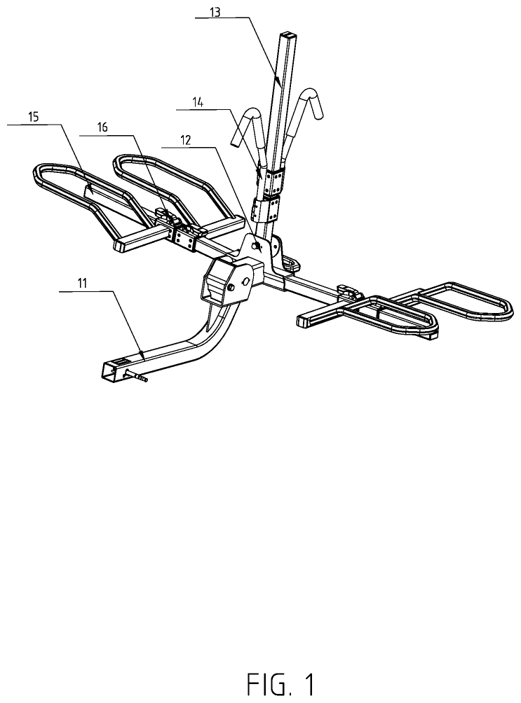

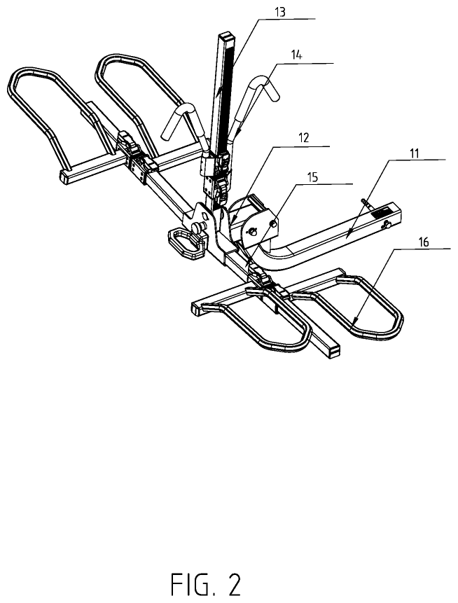

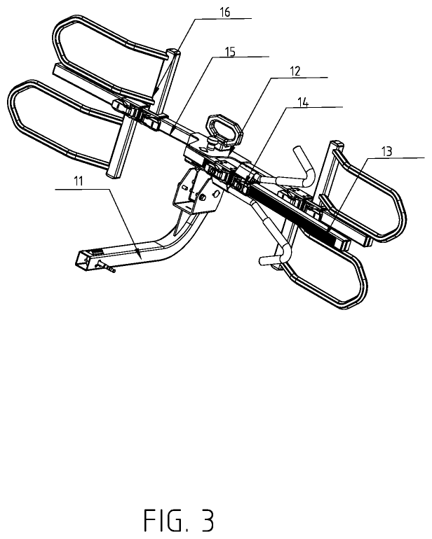

Referring to FIG. 1-FIG. 4, the folding platform type bicycle carrier of the present disclosure includes a fixed connection mechanism 11, a rotating mechanism 12, a longitudinal adjustment rod 13, at least one longitudinal adjustment fixing mechanism 14, two transverse adjustment rods 15 and at least two transverse adjustment fixing mechanisms 16. The fixed connection mechanism 11 is detachably connected to a rectangular pipe at the rear part of a vehicle; the rotating mechanism 12 is movably connected to the fixed connection mechanism 11 and can rotate relative to the fixed connection mechanism 11; the longitudinal adjustment rod 13 is movably arranged above the rotating mechanism 12 and can be folded relative to the rotating mechanism 12; the at least one longitudinal adjustment fixing mechanism 14 is movably arranged on the longitudinal adjustment rod 13 and can move on the longitudinal adjustment rod 13, so as to longitudinally fix a bicycle placed on the platform type bicycle carrier; the two transverse adjustment rods 15 are respectively arranged on two sides of the rotating mechanism 12; and the at least two transverse adjustment fixing mechanisms 16 are respectively movably arranged on the corresponding transverse adjustment rods 15, and can move on the corresponding transverse adjustment rods 15, so as to transversely fix the bicycle placed on the platform type bicycle carrier.

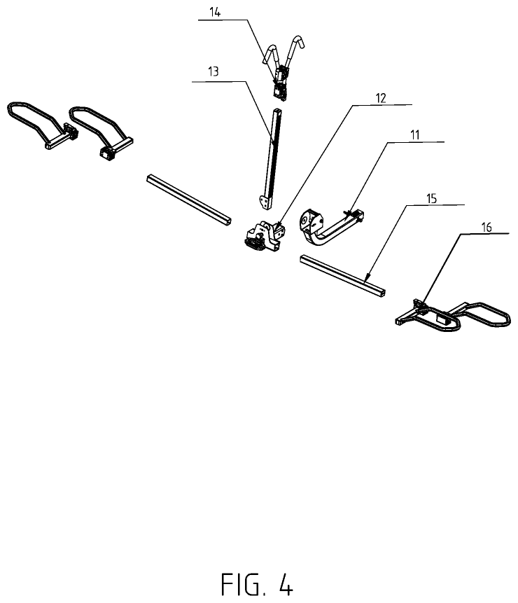

Referring to FIG. 4-FIG. 6, in this embodiment, the fixed connection mechanism 11 includes a connection pipe 111, a fixed connection structure 112 and a connection head 113; the connection pipe 111 is a hollow pipe, which is detachably connected to the rectangular pipe at the rear part of the vehicle through the fixed connection structure 112; the fixed connection structure 112 is arranged in one end of the connection pipe 111 and runs through the connection pipe 111 to be in contact connection with the rectangular pipe, so that the connection pipe 111 is fixedly connected to the rectangular pipe; and two ends of the connection head 113 are respectively connected to the connection pipe 111 and the rotating mechanism 12.

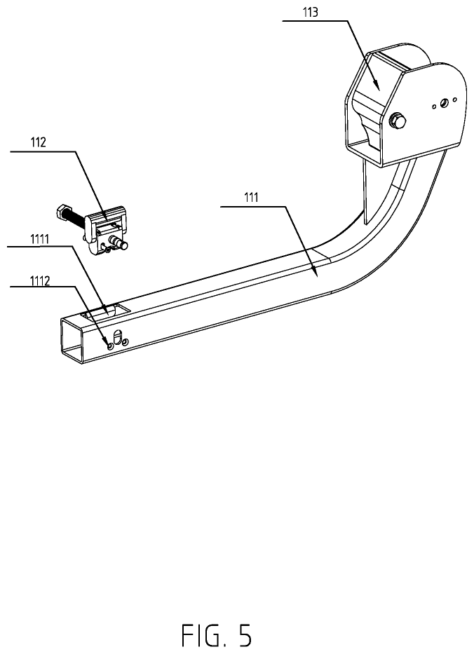

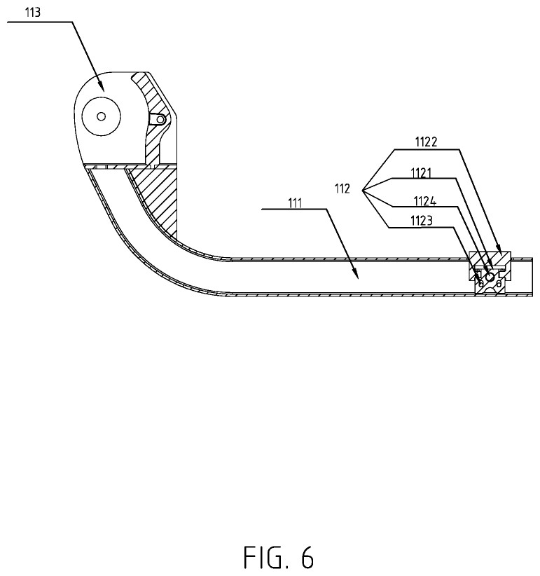

Referring to FIG. 5 and FIG. 6, in this embodiment, a via hole 1111 and a plurality of first through holes 1112 are formed in the connection pipe 111; the via hole 1111 is arranged above the connection pipe 111; the fixed connection structure 112 runs through the via hole 1111 and is connected to the rectangular pipe; and the plurality of first through holes 1112 symmetrically run through two sides of the first connection pipe 111 respectively.

Referring to FIG. 5 and FIG. 6, in this embodiment, the fixed connection structure 112 includes a guide block 1121, a fastening block 1122, at least one guide rod 1123 and a screw rod 1124; the guide block 1121 is movably arranged in the connection pipe 111, and an internal thread is formed in the guide block; the fastening block 1122 is movably arranged on the guide block 1121, runs through the connection pipe 111, and can be in contact connection with an inner wall of the rectangular pipe; the fastening block 1122 moves with the movement of the guide block 1121; two ends of the at least one guide rod 1123 are respectively fixedly arranged on opposite inner walls of the connection pipe 111; the guide block 1121 is arranged on the at least one guide rod 1123 in a penetrating manner; the guide block 1121 can move on the at least one guide rod 1123; the screw rod 1124 is detachably connected to the guide block 1121, and an external thread is arranged on the screw rod; the external thread is matched with the internal thread on the guide block 1121, so that the guide block 1121 moves on the at least one guide rod 1123; the guide block 1121 drives the fastening block 1122 to move, so that the fastening block 1122 is fastened to the rectangular pipe; and the at least one guide rod 1123 and the screw rod 1124 respectively run through the connection pipe 111 through the corresponding first through holes 1112. In this embodiment, the two guide rods 1123 are disposed in parallel; and the guide block 1121 is movably arranged on the two guide rods 1123 respectively. In other embodiments, the number of the guide rods 1123 may be one, three or multiple. The number of the guide rods 1123 may be correspondingly set according to an actual need. In this embodiment, two ends of the guide rods 1123 are respectively fixed on the connection pipe 111 through screws.

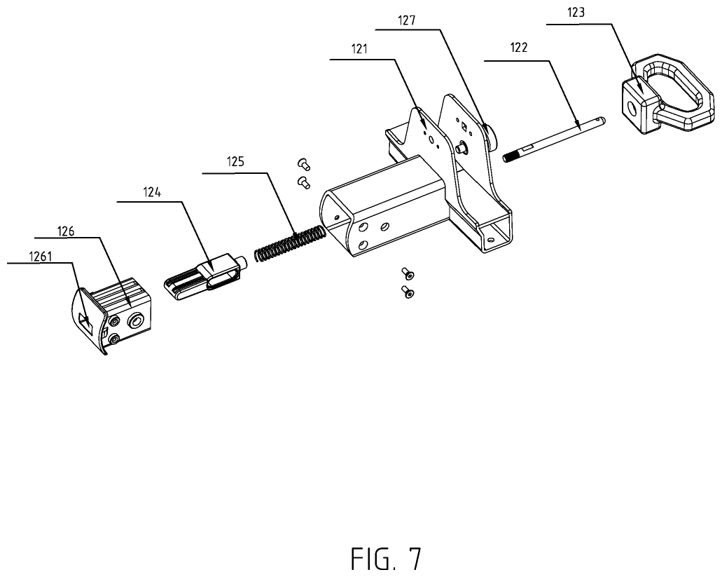

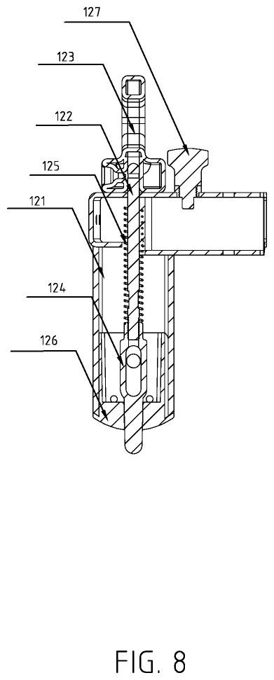

Referring to FIG. 4, FIG. 7 and FIG. 8, in this embodiment, the rotating mechanism 12 includes a rotating cavity 121, a connection rod 122, a pull handle 123, a connection block 124, an elastic piece 125 and a rotating head 126; the rotating cavity 121 is a hollow cavity, which can rotate relative to the fixed connection mechanism 11 through a rotating shaft; the rotating rod 122 is movably arranged in the rotating cavity 121; one end of the connection rod is fixedly connected to the pull handle 123, and the other end of the connection rod 122 is fixedly connected to the connection block 124; the pull handle 123 is movably arranged on an outer side of the rotating cavity 121; the pull handle 123 is pulled outwards forcibly to drive the connection rod 122 and the connection block 124 to move to the outside in sequence; the connection block 124 is arranged in the rotating cavity 121 and can run through the rotating head 126; the connection block 124 is connected to a through hole formed in the connection head 113 when running through the rotating head 126, so that the rotating mechanism 12 is fixedly connected to the fixed connection mechanism 11; when the connection block 124 is separated from the through hole in the connection head 113, the rotating mechanism 12 can rotate relative to the fixed connection mechanism 11; the elastic piece 125 is arranged on the connection rod 122 in a penetrating manner; one end of the elastic piece is connected to the connection block 124, and the other end of the elastic piece 125 is fixedly arranged in the rotating cavity 121, so as to provide a restoring force for the connection rod 122; when an external force acts on the pull handle 123, the connection rod 122 and the connection block 124 are driven to move to the outside in sequence, and the elastic piece 125 is compressed at the same time; when the external force acting on the pull handle 123 disappears, the connection rod 122 drives, under the action of the restoring force of the elastic piece 125, the connection block 124 to return to an initial position, so that the connection block 124 can be connected to the connection head 113, and the rotating mechanism 12 is fixedly connected to the fixed connection mechanism 11; and the rotating head 126 is fixedly arranged at one end of the rotating cavity 121 and can rotate relative to the connection head 113.

Referring to FIG. 8, in this embodiment, the rotating cavity 121 is T-shaped; the longitudinal adjustment rod 13 is movably arranged in a longitudinal direction of the rotating cavity 121; the two transverse adjustment rods 15 are fixedly arranged on two sides of the rotating cavity 121; a side edge of the rotating cavity 121 is movably provided with a limiting pin 127; and the limiting pin 127 can be in contact connection with the longitudinal adjustment rod 13. When the limiting pin 127 is connected to the longitudinal adjustment rod 13, the longitudinal adjustment rod 13 is fixedly connected to the rotating mechanism 12; when the limiting pin 127 is separated from the longitudinal adjustment rod 13, the longitudinal adjustment rod 13 can rotate relative to the rotating mechanism 12, thus realizing a function of folding the longitudinal adjustment rod 13. In this embodiment, specifically, the elastic piece 125 adopts a spring. A front end of the rotating head 126 is provided with a second through hole 1261, and the connection block 124 runs through the rotating head 126 and the connection head 113 through the second through hole 1261.

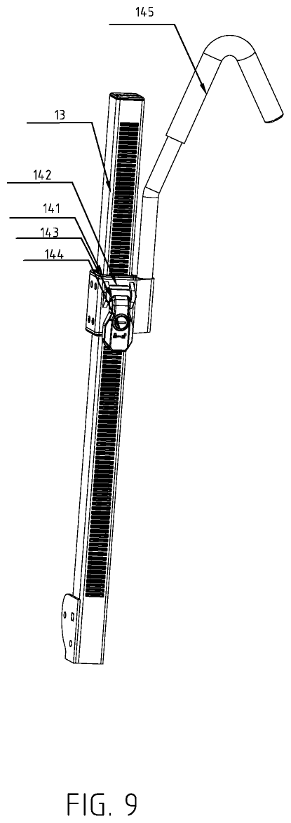

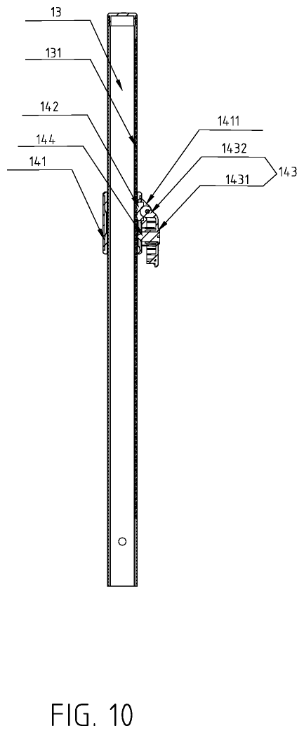

Referring to FIG. 4, FIG. 9 and FIG. 10, in this embodiment, a plurality of adjustment toothed racks 131 are uniformly arranged on the longitudinal adjustment rod 13 at equal distances; and each longitudinal adjustment fixing mechanism 14 is matched with the corresponding adjustment toothed rack 131, so as to be fixed on the longitudinal adjustment rod 13. In this embodiment, each longitudinal adjustment fixing mechanism 14 includes a sliding cavity 141, a fastening block 142, a pressing block 143 and a longitudinal fixing rod 145; the sliding cavity 141 is a hollow cavity, which is movably arranged on the longitudinal adjustment rod 13; and the fastening block 142 is movably arranged between the sliding cavity 141 and the pressing block 143 and can be in contact connection with the longitudinal adjustment rod 13. Since the fastening block 142 is matched with the corresponding adjustment toothed rack 131, the longitudinal adjustment fixing mechanism 14 is fixed on the longitudinal adjustment rod 13; the pressing block 143 is movably arranged on the sliding cavity 141 and is in contact connection with the fastening block 142; the pressing block 143 presses the fastening block 142, so that the fastening block 142 is fastened with the corresponding adjustment toothed rack 131, thus achieving a fixing effect; the longitudinal fixing rod 145 is fixedly arranged on a side edge of the sliding cavity 141; the sliding cavity 141 is adjusted to drive the longitudinal fixing rod 145 to move and be in close contact with the bicycle; and the fastening block 142 and the pressing block 143 are matched to longitudinally fix the bicycle on the platform type bicycle carrier. In this embodiment, a lock body 144 is further arranged on the pressing block 143; and the pressing block 143 is fixed on the sliding cavity 141 through the lock body 144, so that the pressing block 143 is prevented from being loosened, and an anti-theft function is achieved.

Referring to FIG. 9 and FIG. 10, in this embodiment, the pressing block 143 includes a pressing block main body 1431 and a pressing block head 1432; the pressing block head 1432 is arranged at one end of the pressing block main body 1431, is movably arranged on the sliding cavity 141, and can rotate relative to the sliding cavity 141; the pressing block head 1432 is a cylinder, and the fastening block 142 is a groove; and the pressing block head 1432 and the fastening block 142 are matched to adjust and fasten the longitudinal adjustment fixing mechanism 14 on the longitudinal adjustment rod 13 according to the size of the bicycle. In this embodiment, the two longitudinal adjustment fixing mechanisms 14 are movably arranged on the longitudinal adjustment rod 13. In other embodiments, there may be one longitudinal adjustment fixing mechanism 14 movably arranged on the longitudinal adjustment rod 13.

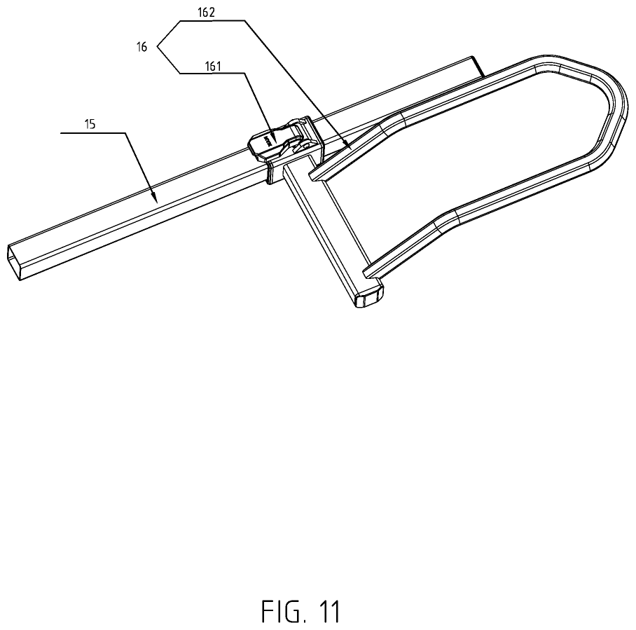

Referring to FIG. 4 and FIG. 11, in this embodiment, the two transverse adjustment rods 15 are symmetrically arranged on two sides of the rotating mechanism 12; a plurality of adjustment toothed racks 131 are also uniformly arranged on the transverse adjustment rods 15 at equal distances; and the transverse adjustment fixing mechanisms 16 are fixed on the transverse adjustment rods 15 by means of being matched with the corresponding adjustment toothed racks 131. In this embodiment, two transverse adjustment fixing mechanisms 16 are movably arranged on each transverse adjustment rod 15; and the two transverse adjustment fixing mechanisms 16 are respectively arranged on two sides of the transverse adjustment rod 15. In other embodiments, there may be also one transverse adjustment fixing mechanism 16 movably arranged on the transverse adjustment rod 15.

Referring to FIG. 11, in this embodiment, the transverse adjustment fixing mechanism 16 includes an adjustment fixing structure 161 and a transverse fixing rod 162; the adjustment fixing structure 161 is movably arranged on the corresponding transverse adjustment rod 15; the transverse fixing rod 162 is fixedly arranged at a side edge of the adjustment fixing structure 161; and the adjustment fixing structure 161 is structurally similar to the longitudinal adjustment fixing mechanism 14, so that its specific structure will not be repeatedly described here.

It should be noted that according to the folding platform type bicycle carrier of the present disclosure, the pull handle 123 is pulled outwards to drive the connection rod 122 and the connection block 124 to move to the outside in sequence, and the elastic piece 125 is compressed at the same time, so that the fixed connection between the connection block 124 and the connection head 113 is cut off, and the rotating mechanism 12 can rotate relative to the fixed connection mechanism 11; the rotating mechanism 12 drives the transverse adjustment rods 15 that are in fixed connection to rotate, and the transverse adjustment fixing mechanisms 16 arranged on the transverse adjustment rods 15 also rotate therewith, thus realizing a function of folding the transverse adjustment rods 15 and the transverse adjustment fixing mechanisms 16 respectively relative to the fixed connection mechanism 11. The limiting pin 127 is pulled to be separated from the longitudinal adjustment rod 13; and the longitudinal adjustment rod 13 can rotate relative to the rotating mechanism 12, and the longitudinal adjustment fixing mechanisms 14 arranged on the rotating mechanism 12 also rotate therewith, thereby realizing a function of folding the longitudinal adjustment rod 13 and the longitudinal adjustment fixing mechanisms 14 respectively relative to the rotating mechanism 12.

The technical features of the embodiments described above can be arbitrarily combined. In order to make the description concise, all possible combinations of various technical features in the above embodiments are not completely described. However, the combinations of these technical features should be considered as the scope described in this specification as long as there is no contradiction m them.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. A folding platform type bicycle carrier,
comprising a fixed connection mechanism, which is detachably connected to a rectangular pipe at the rear part of a vehicle;
a rotating mechanism, which is movably connected to the fixed connection mechanism and rotates relative to the fixed connection mechanism, wherein the rotating mechanism comprises a rotating cavity, a connection rod, a pull handle, a connection block, an elastic piece and a rotating head; the rotating cavity is a hollow cavity, which rotates relative to the fixed connection mechanism through a rotating shaft; the rotating rod is movably arranged in the rotating cavity, and two ends of the rotating rod are respectively fixedly connected to the pull handle and the connection block; the pull handle is movably arranged on an outer side of the rotating cavity, and drives the connection rod and the connection block to move to the outside in sequence; the connection block is arranged in the rotating cavity and runs through the rotating head; the elastic piece is arranged on the connection rod in a penetrating manner, and two ends of the elastic piece are respectively connected to the connection block and an inner wall of the rotating cavity; the elastic piece provides a restoring force for the connection rod; the rotating head is fixedly arranged at one end of the rotating cavity and rotates relative to the fixed connection mechanism;
a longitudinal adjustment rod, which is movably arranged above the rotating mechanism and is folded relative to the rotating mechanism;
at least one longitudinal adjustment fixing mechanism, which is movably arranged on the longitudinal adjustment rod and moves on the longitudinal adjustment rod;
two transverse adjustment rods, which are respectively arranged on two sides of the rotating mechanism; and
at least two transverse adjustment fixing mechanisms, which are respectively movably arranged on the corresponding transverse adjustment rods, wherein each transverse adjustment fixing mechanism moves on the corresponding transverse adjustment rod.

2. The folding platform type bicycle carrier according to claim 1, wherein the fixed connection mechanism comprises a connection pipe, a fixed connection structure and a connection head; the connection pipe is a hollow pipe, which is detachably connected to the rectangular pipe at the rear part of the vehicle through the fixed connection structure; the fixed connection structure is arranged in one end of the connection pipe and runs through the connection pipe to be in contact connection with the rectangular pipe; and two ends of the connection head are respectively connected to the connection pipe and the rotating mechanism.

3. The folding platform type bicycle carrier according to claim 2, wherein a via hole is formed in the connection pipe; the via hole is arranged above the connection pipe; and the fixed connection structure runs through the via hole and is connected to the rectangular pipe.

4. The folding platform type bicycle carrier according to claim 2, wherein the fixed connection structure comprises a guide block, a fastening block, at least one guide rod and a screw rod; the guide block is movably arranged in the connection pipe, and an internal thread is formed in the guide block; the fastening block is movably arranged on the guide block, runs through the connection pipe, and is in contact connection with an inner wall of the rectangular pipe; two ends of the at least one guide rod are respectively fixedly arranged on opposite inner walls of the connection pipe; the screw rod is detachably connected to the guide block, and an external thread is arranged on the screw rod; and the external thread is matched with the internal thread.

5. The folding platform type bicycle carrier according to claim 4, wherein a plurality of first through holes are formed in a side edge of the connection pipe in a penetrating manner; and the at least one guide rod and the screw rod respectively run through the connection pipe through the corresponding first through holes.

6. The folding platform type bicycle carrier according to claim 4, wherein the two guide rods are disposed in parallel; and the guide block is movably arranged on the two guide rods respectively.

7. The folding platform type bicycle carrier according to claim 1, wherein the rotating cavity is T-shaped; the longitudinal adjustment rod is movably arranged in a longitudinal direction of the rotating cavity; and the two transverse adjustment rods are fixedly arranged on two sides of the rotating cavity.

8. The folding platform type bicycle carrier according to claim 7, wherein a side edge of the rotating cavity is movably provided with a limiting pin; and the limiting pin is in contact connection with the longitudinal adjustment rod.

9. The folding platform type bicycle carrier according to claim 1, wherein the elastic piece adopts a spring.

10. The folding platform type bicycle carrier according to claim 1, wherein a plurality of adjustment toothed racks are uniformly arranged on the longitudinal adjustment rod at equal distances, and each longitudinal adjustment fixing mechanism is matched with the corresponding adjustment toothed rack.

11. The folding platform type bicycle carrier according to claim 10, wherein the longitudinal adjustment fixing mechanism comprises a sliding cavity, a fastening block and a pressing block; the sliding cavity is a hollow cavity, which is movably arranged on the longitudinal adjustment rod; the fastening block is movably arranged between the sliding cavity and the pressing block and is in contact connection with the longitudinal adjustment rod; the pressing block is movably arranged on the sliding cavity and is in contact connection with the fastening block; and the pressing block presses the fastening block, so that the fastening block is fastened with the corresponding adjustment toothed rack.

12. The folding platform type bicycle carrier according to claim 11, wherein the longitudinal adjustment fixing mechanism further comprises a longitudinal fixing rod; and the longitudinal fixing rod is fixedly arranged on a side edge of the sliding cavity.

13. The folding platform type bicycle carrier according to claim 11, wherein a lock body is arranged on the pressing block; and the pressing block is fixed on the sliding cavity through the lock body.

14. The folding platform type bicycle carrier according to claim 1, wherein two transverse adjustment fixing mechanisms are movably arranged on each transverse adjustment rod; and the two transverse adjustment fixing mechanisms are respectively arranged on two sides of the corresponding transverse adjustment rod.

15. The folding platform type bicycle carrier according to claim 14, wherein each transverse adjustment fixing mechanism comprises an adjustment fixing structure and a transverse fixing rod; the adjustment fixing structure is movably arranged on the corresponding transverse adjustment rod; and the transverse fixing rod is fixedly arranged on a side edge of the adjustment fixing structure.
